(19) United States
(12) Patent Application Publication
(10) Pub. No.: US 2022/0383761 A1
(43) Pub. Date: Dec. 1, 2022

(54) DYNAMIC NAVIGATION PROCEDURES

(71) Applicant: Rockwell Collins, Inc., Cedar Rapids, IA (US)

(72) Inventors: Michael J. Krenz, Roscoe, IL (US); Ellen L. McGaughy, Cedar Rapids, IA (US)

(21) Appl. No.: 17/333,980

(22) Filed: May 28, 2021

(51) Int. Cl. G08G 5/00; G05D 1/10; G05D 1/06

(52) U.S. Cl. CPC G08G 5/0047; G08G 5/003; G08G 5/0013; G05D 1/104; G05D 1/0607

(57) ABSTRACT

A system for aircraft navigation is disclosed. The system comprises an aircraft traffic control (ATC) computing device configured to generate a navigation procedure including at least: a starting waypoint, an assigned vector, and four-dimensional (4D) trajectory information. A computing device on-board an aircraft is configured to: receive the navigation procedure via controller-pilot datalink communications (CPDLC), display the navigation procedure to a user of the aircraft, and responsive to the user of the aircraft selecting the navigation procedure, automatically control the aircraft based on the navigation procedure.

### SUMMARY

A system for aircraft navigation is disclosed in accordance with one or more illustrative embodiments of the present disclosure. In one illustrative embodiment, the system comprises an aircraft traffic control (ATC) computing device configured to generate an navigation procedure including at least: a starting waypoint; an assigned vector; and four-dimensional (4D) trajectory information. In another illustrative embodiment, the system comprises a computing device on-board an aircraft configured to: receive the navigation procedure via controller-pilot datalink communications (CPDLC); display the navigation procedure to a user of the aircraft; and responsive to the user of the aircraft selecting the navigation procedure, automatically control the aircraft based on the navigation procedure.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF DRAWINGS

The numerous advantages of the disclosure may be better understood by those skilled in the art by reference to the accompanying figures in which:

FIG. 1 is a box diagram of an aircraft navigation system, in accordance with one or more embodiments of the present disclosure.

FIG. 2 is an approach procedure chart, in accordance with one or more embodiments of the present disclosure.

FIG. 3 is the approach procedure chart of FIG. 2 with a navigation procedure defined by an air traffic controller overlaid thereon, in accordance with one or more embodiments of the present disclosure.

### DETAILED DESCRIPTION

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. In the following detailed description of embodiments of the present disclosure, numerous specific details are set forth in order to provide a more thorough understanding of the inventive concepts. However, it will be apparent to one of ordinary skill in the art having the benefit of the present disclosure that the inventive concepts disclosed herein may be practiced without these specific details. In other instances, well-known features may not be described in detail to avoid unnecessarily complicating the present disclosure. The inventive concepts disclosed herein are capable of other embodiments or of being practiced or carried out in various ways. Also, it is to be understood that the phraseology and terminology employed herein is for the purpose of description and should not be regarded as limiting.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only, and should not be construed to limit the inventive concepts disclosed herein in any way unless expressly stated to the contrary. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). In addition, use of the “a” or “an” are employed to describe elements and components of embodiments of the present inventive concepts. This is done merely for convenience and to give a general sense of the inventive concepts, and “a” and “an” are intended to include one or at least one and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment of the inventive concepts disclosed herein. The appearances of the phrase “in some embodiments” in various places in the specification are not necessarily all referring to the same embodiment, and embodiments of the inventive concepts disclosed may include one or more of the features expressly described or inherently present herein, or any combination or sub-combination of two or more such features, along with any other features which may not necessarily be expressly described or inherently present in the present disclosure.

Air Traffic Control (ATC) systems rely on periodically updated navigation procedures that are stored on aircraft as electronic databases, paper charts, or electronic representations of the paper charts. The infrastructure required to update the charts is extensive, and still only permits chart updates about twice a month. Moreover, the AIRAC cycle requires states to publish normal changes at least 42 days ahead of the date that the chart becomes effective. Onboard database updates can be performed via datalink (e.g. WiFi), however the updates are performed manually by a pilot/mechanic and are signed off when completed. Additional notices to airmen (NOTAMs) can be issued for emergency limitations on the charts at any time, but must be manually recognized and incorporated by the pilots and controllers. Thus, it is not feasible to dynamically tweak the procedures due to operational constraints such as weather, malfunctioning or unavailable equipment, aircrew limitations, traffic density, etc. With the advent of urban air mobility (e.g., personal air vehicles), the problem worsens as increasing numbers of discrete aircraft share common airspace.

Air traffic management (ATM) is shifting toward Trajectory Based Operations (TBO), a concept that enhances strategic planning of aircraft flows to reduce capacity-to-demand imbalances in the National Airspace System (NAS), and provides tools to air traffic management personnel and controllers to help expedite aircraft movement between origin and destination airports. Through improved strategic planning and management of traffic flows, TBO helps reduce reactive decision-making and use of static miles-in-trail (MIT) restrictions.

Miles-in-trail describes the number of miles required between aircraft departing an airport, over a fix, at an altitude, thru a sector, or on a specific route. MIT is used to apportion traffic into a manageable flow, as well as to provide space for additional traffic (merging or departing) to enter the flow of traffic. Normally MIT is implemented in response to a specific situation.

For example, standard separation between aircraft in the enroute environment is five nautical miles. During a weather event, this separation may increase significantly. Many delays are directly attributable to MIT. A variation on MIT is minutes-in-trail (MINIT). Minutes-in-trail describe the minutes needed between successive aircraft. It is normally used when aircraft are operating in a non-radar environment or transitioning to/from a non-radar environment. It may also be used if additional spacing is required due to aircraft deviating around weather. Delays resulting from both MIT and MINIT are normally manifested as departure delays. However, these restrictions can also be put into place after departure, resulting in speed restrictions and possible airborne holding.

Aircraft trajectory is the core tenant of TBO and is defined in four dimensions: latitude, longitude, altitude and time. The trajectory represents a common reference for the aircrafts expected location at key points along its route. The trajectory is defined prior to departure, updated in response to emerging conditions and operator inputs, and shared between stakeholders and systems. The aggregate set of aircraft trajectories on the day-of-operation defines demand, and informs traffic management actions. A “day-of operation” refers to operating conditions during the day an operation takes place, including equipment outages, weather, airport conditions, airline delays and cancelations, and other temporary conditions in the NAS.

The key elements of TBO include: (i) Time Based Management (TBM), which helps manage traffic flows and trajectories by scheduling and metering aircraft through congested NAS resources or constraint points, (ii) Performance Based Navigation (PBN), which enables aircraft to more accurately navigate along their trajectories, and enables decision support tools to improve feasibility of schedules for constraint points as well as achieve greater compliance to schedules, and (iii) Enabling Technologies, which expand and automate sharing of common information about aircraft trajectories, and include System-wide Information Management (SWIM), Data Communications, enhanced data exchange and many others.

Embodiments of the present disclosure advantageously complement the TBO solution framework by providing a means for Air Traffic Control to dynamically define dynamic navigation procedures that can be uplinked and utilized as portions of a flight plan. The dynamic navigation procedures may include full 4D trajectory information and additional information such as pre-loaded voice channel frequency changes at specific points along the path. The embodiments of the present disclosure combine the use of existing charts and procedures with the ability of the ground ATC to dynamically specify new procedures. When both the aircraft and the ground ATC are equipped to do so, the air traffic controller can send up a series of instructions (i.e., a miniature flight plan) that the crew can review and accept. The navigation procedure may then be implemented using the flight management system and autopilot system on-board the aircraft.

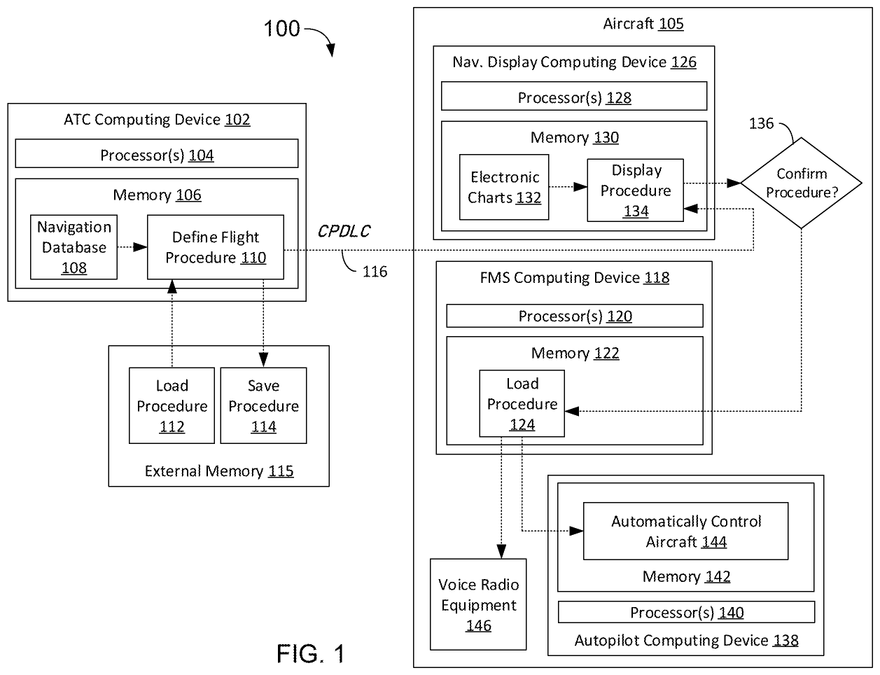

FIG. 1 is a box diagram illustrating an aircraft navigation system 100, in accordance with one or more embodiments of the present disclosure. The system 100 includes an ATC computing device 102 that may be, for example, located at a ground ATC tower and may be operated by one or more air traffic controllers. The ATC computing device 102 may be communicatively coupled to an aircraft 105 by controller-pilot data link communications (CPDLC) 116. The CPDLC 116 may comprise a VHF Data Link or VHF Digital Link (VDL), may operate using the ICAO VDL Mode 2 version. The aircraft 105 further includes a flight management system (FMS) computing device 118, a navigation display computing device 126, and an autopilot computing device 138.

The ATC computing device 102, FMS computing device 118, navigation display computing device 126, and autopilot computing device 138 may each respectively include one or more processors 104, 120, 128, and 140 and a memory 106, 122, 130, and 142. For the purposes of the present disclosure, the term “processor” or “processing element” may be broadly defined to encompass any device having one or more processing or logic elements, for example, one or more central processing units (CPUs), one or more graphics processing units (GPUs), one or more micro-processor devices, one or more application specific integrated circuit (ASIC) devices, one or more field programmable gate arrays (FPGAs), or one or more digital signal processors (DSPs). In this sense, the one or more processors may include any device configured to execute algorithms and/or instructions (e.g., program instructions stored in memory), and may be configured to perform the method steps described in the present disclosure. The memory may include any storage medium known in the art suitable for storing program instructions executable by the associated one or more processors. For example, the memory medium may include, but is not limited to, a read-only memory (ROM), a random-access memory (RAM), a magnetic or optical memory device (e.g., hard disk), a magnetic tape, a solid-state drive, and the like.

The ATC computing device 102 may be configured to generate a dynamic navigation procedure. A user (e.g., air traffic controller) of the system 100 may define the navigation procedure 110 using an input device (not shown) and a display (not shown). The aircraft controller may select a navigation chart to be presented on the display, and the controller may then define the procedure 110 using the input device. The user may access a navigation database 108 that includes up-to-date information related to air traffic operations in the vicinity (for example, the trajectories of nearby aircraft, weather, etc.). The display may overlay the information from the navigation database 108 on a navigation chart. In some embodiments, the input device may comprise a mouse, keyboard, keypad, a touch-screen, etc. The display may comprise a CRT monitor, LCD monitor, etc. The ATC computing device 102 may be a personal computer, a laptop, a smartphone, a tablet, a server computer, a mainframe, etc.

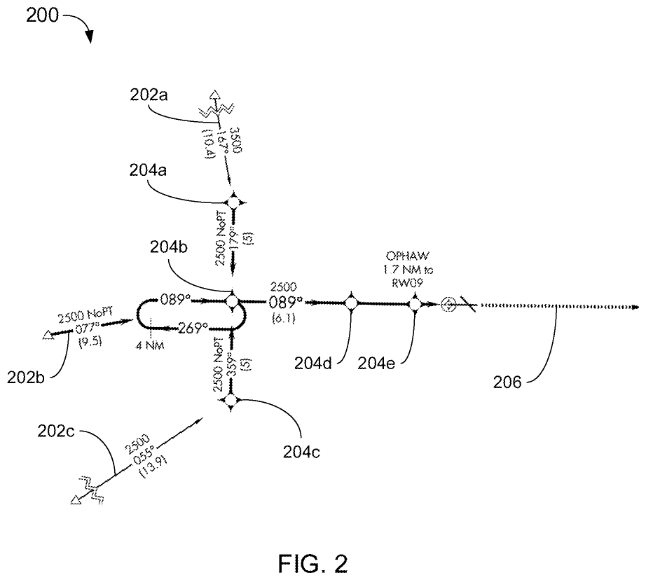

FIG. 2 shows a conventional instrument approach procedure chart 200 (e.g., approach plate) of the Eastern Iowa Airport (Cedar Rapids, IA) abbreviated for simplicity. The chart 200 displays approaches 202a-c, waypoints 204a-e, and a runway 206. In a conventional operation, the approaches 202a-c are fixed and additional approaches are typically not available for landing aircraft. During times of inclement weather, this restricted number of approaches may cause a high intensity of traffic at a small number of approaches, complicating the ability of air traffic controllers to manage the aircraft effectively and timely.

Although horizontal and vertical waypoints 204a-e and path definitions are shown, the chart 200 typically may include additional information such as navaid frequencies, ATC frequencies, approach lighting type information, landing zone information, minimum required ceiling and visibility, missed approach instructions, and other miscellaneous notes. Dynamically defined navigation procedures 110 that are uploaded to the aircraft 105 may include this additional information. Although some cockpits can display the additional information as a combined 3D image, there may be more effective ways to present the information to the crew.

In addition to the information conventionally included in approach charts, or arrival/departure charts, additional information such as speed constraints may be included in the procedure 110. To reduce confusion, information may be excluded if not relevant to the current flight. For example, the chart 200 displays three possible Initial Approach Fixes (waypoints 204a, 204b, and 204c), however, a single IAF may selected as the IAF for a particular arriving flight. The navigation procedure 110 may selectively remove IAFs from pre-published procedures (leaving only the selected IAF to be shown). The removal of unused IAFs may occur whenever an IAF is selected as part of the dynamic procedure 110 (i.e., the exit point or ending waypoint).

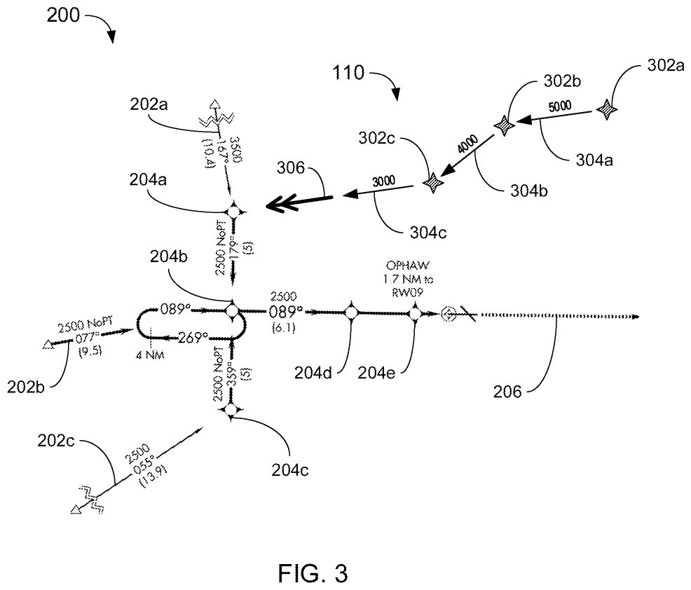

FIG. 3 shows the chart 200 of FIG. 2 with the procedure 110 overlaid thereon, in accordance with one or more embodiments of the present disclosure. The air traffic controller may define the procedure 110 to include a starting waypoint, an assigned vector, and 4D trajectory information. As shown, the starting waypoint may be defined as the waypoint 302a, and the assigned vector may be defined as vector 306. In some embodiments, one or more intermediate waypoints may be defined between the starting waypoint and the assigned vector, for example, the waypoints 302b and 302c. The waypoints 302a-c and assigned vector 306 may be defined (e.g., selected or set by the user) by clicking (using a mouse), finger taps (using a touchscreen), or manually by entering the latitude, longitude, altitude, speed, and/or heading (using a keyboard). The generation of dynamic navigation procedures 110 may be restricted to the area where the relevant ATC is already authorized to control or vector air traffic. Pre-published procedures, on the other hand, usually require surveys and flight tests for validation prior to use.

The assigned vector 306 may be a course by which the aircraft 105 joins the next flight segment (for example, departure transitioning to en-route, terminal transitioning to final approach, etc.). The assigned vector 306 may include heading information, altitude information, and speed information. In some embodiments, the procedure may terminate at the assigned vector 306. The assigned vector 306 may be employed when intercepting another pre-published procedure (e.g., a published approach segment, airway, Standard Instrument Departure, Standard Terminal Arrival Route, oceanic track, etc.). At any point during the execution of the procedure 110, ATC may intervene and override the procedure 110, for example, when providing an early turn to intercept a pre-published final approach course.

In some embodiments, the procedure may include one or more ending waypoints (e.g., in addition to the assigned vector 306). On approach, the aircraft 105 may be directed to one of a plurality of ending waypoints for the turn to the runway 206 (e.g., after the aircraft 105 reaches the assigned vector 306, ATC may take over to command the aircraft 105 to base and final approach). In one example, the ending waypoint is defined as an IAF (e.g., waypoint 204a or waypoint 204c).

The 4D trajectory information may include altitude, longitude, latitude, time, and speed for each of the flight legs 304a, 304b, and 304c between the waypoints. For example, the 4D trajectory information may instruct the aircraft 105 to cruise at an altitude of 5000 feet between the waypoints 302a and 302b, an altitude of 4000 feet between 302b and 302c, and an altitude of 3000 feet between the waypoints 302c and 204a. Additionally, the 4D trajectory information may include minutes-in-trail information (e.g., so that three minutes elapse between each aircraft landing). The start and end of the dynamic procedure 110 may be integrated with other predefined procedures (or airway definitions) in the system, allowing the ATC controller to provide clearance to the aircraft 105 to enter at any point in the controlled airspace, and also to provide linkage to other routes/procedures/clearances at any exit point.

In some embodiments, the procedure 110 may include voice channel frequency changes at one or more of the waypoints 302a-c. The voice channel frequency (e.g., used for the headset communication between the pilot and the ATC controller) may be changed manually or automatically in response to the aircraft arriving or passing a designated waypoint (e.g., using an interface to voice radio equipment 146). For example, the aircraft 105 may communicate at a first voice frequency during the flight leg 304a, and, in response to passing the waypoint 302b, may communicate at a second voice frequency during the flight leg 304c. This functionality may be valuable at airports where there exist multiple possible frequencies depending upon runway or geographic location. Additionally, in some embodiments, the procedure 110 may include transfer of control of the CPLDC 116 by an ATC controller to other ATC controllers (for example, when the aircraft 105 transitions from terminal to en-route, from domestic to oceanic, etc.).

In some embodiments, the procedure 110 may be generated by the ATC computing device 102 based on a track recorded by a lead aircraft (e.g., that is originally manually vectored by a controller). The track may record turns, altitude and speed adjustments of the lead aircraft. The air traffic controller may edit or tweak the procedure generated by the track (by changing the starting waypoint, 4D trajectory information, assigned vector, intermediate waypoints, ending waypoint, etc.), and may store the procedure as a dynamic navigation procedure 110. The dynamic navigation procedure 110 based on the recorded track may be uploaded to subsequent aircraft, enabling the controller to clear the subsequent aircraft to follow the same route with a single instruction or clearance. Tracks recorded by air traffic controllers may be saved in account profiles in the memory 106 and/or the memory 115 (enabling repeated use of the tracks, even in subsequent shifts). In some embodiments, air traffic controllers may share common tracks. By storing a catalog of tracks on the ground (e.g., on the memory 106 of the ATC computing device 102), clutter may be substantially reduced from aircraft navigation databases. By data-linking only the procedure 110 desired to the aircraft 105, confusion between similar tracks (that may differ only in an assigned speed) may be eliminated.

Referring back to FIG. 1, an external memory 115 may be communicatively coupled to the ATC computing device 102. The external memory 115 may be, for example, a universal serial bus (USB) flash drive, an external hard drive, etc. The external memory 115 may be configured to save 114 the procedure 110 such that the procedure 110 is stored in the external memory 115 for later retrieval. The external memory 115 may load 112 the procedure 110 from the external memory 115 onto the ATC computing device 102 such that the procedure 110 is available for access in the memory 106. In this way, air traffic controllers may store a plurality of procedures 110 for fast retrieval in variety of air traffic conditions.

The procedure 110 may then be transmitted to the aircraft 105 via the CPDLC 116. The procedure 110 may be overlaid on an electronic chart 132, and may be displayed 134 to the user of the aircraft (e.g., the pilot) using the navigation display computing device 126 (e.g., a flight display). After the user of the aircraft 105 reviews the procedure 110 (e.g., the starting waypoint, intermediate waypoints, assigned vector, and 4D trajectory information), the user of the aircraft 105 may then confirm 136 the procedure 110. After the procedure 110 is confirmed, the procedure 110 may be loaded 124 into the FMS computing device 118 (e.g., the flight management system) such that the flight plan of the aircraft 105 implements the procedure 110. Accordingly, the autopilot computing device 138 may then automatically control 144 the aircraft 105 based on the procedure 110. For example, the autopilot computing device 138 may control one or more flight surfaces (e.g., ailerons, elevator, rudder, spoilers, flaps) to maneuver the aircraft based on the procedure 110.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A system for aircraft navigation, comprising:
an aircraft traffic control (ATC) computing device configured to:
generate a navigation procedure including at least:
a starting waypoint;
an assigned vector; and
four-dimensional (4D) trajectory information;
an computing device on-board an aircraft configured to:
receive the navigation procedure via controller-pilot datalink communications (CPDLC);
display the navigation procedure to a user of the aircraft; and
responsive to the user of the aircraft selecting the navigation procedure, automatically control the aircraft based on the navigation procedure.

2. The system of claim 1, wherein a user defines the navigation procedure using a display and an input device communicatively coupled to the ATC computing device.

3. The system of claim 1, wherein the assigned vector includes heading information, altitude information, and speed information of the aircraft.

4. The system of claim 1, wherein the 4D trajectory information defines a flight leg between the starting waypoint and the assigned vector.

5. The system of claim 4, wherein the 4D trajectory information includes at least altitude information, longitude information, and latitude information of the aircraft for the flight leg.

6. The system of claim 1, wherein the ATC computing device is configured to save the navigation procedure on a memory external to the ATC computing device.

7. The system of claim 1, wherein the ATC computing device is configured to load the navigation procedure from a memory external to the ATC computing device.

8. The system of claim 1, wherein the navigation procedure includes one or more intermediate waypoints between the starting waypoint and the assigned vector.

9. The system of claim 8, wherein the navigation procedure includes voice channel frequency changes responsive to the aircraft passing at least one of the starting waypoint or the one or more intermediate waypoints.

10. The system of claim 1, wherein the navigation procedure is generated based on a track recorded by a lead aircraft.
